(19) United States
(12) Patent Application Publication
(10) Pub. No.: US 2017/0248739 A1
(43) Pub. Date: Aug. 31, 2017

(54) OPTICAL FILTER AND IMAGING APPARATUS

(71) Applicant: ASAHI GLASS COMPANY, LIMITED, Chiyoda-ku (JP)

(72) Inventors: Atsushi MATSUO, Koriyama-shi (JP); Satoshi UMEDA, Koriyama-shi (JP)

(73) Assignee: ASAHI GLASS COMPANY, LIMITED, Chiyoda-ku (JP)

(21) Appl. No.: 15/597,775

(22) Filed: May 17, 2017

Related U.S. Application Data
(63) Continuation of application No. PCT/JP2015/085994, filed on Dec. 24, 2015.

(30) Foreign Application Priority Data
Dec. 26, 2014 (JP) 2014-265004

(51) Int. Cl. G02B 1/11; G03B 11/04; G02B 5/22; G02B 1/118; G02B 5/28

(52) U.S. Cl. CPC G02B 1/11; G02B 1/118; G02B 5/283; G02B 5/282; G02B 5/223; G03B 11/045

(57) ABSTRACT

Provided is an optical filter used for an imaging apparatus having a built-in image sensing device. The optical filter includes an optical filter body arranged between the subject or the light source and the image sensing device, and having a transmission property for the incident light, and a light shielding film arranged on at least one surface of the optical filter body with a predetermined pattern shielding a part of the incident light. The optical filter body has a transparent substrate, and a first fine uneven structure suppressing reflection of light is provided on at least one interface between the transparent substrate and the light shielding film.

### CROSS-REFERENCE TO RELATED APPLICATIONS

This application is a continuation of prior International Application No. PCT/JP2015/085994, filed on Dec. 24, 2015 which is based upon and claims the benefit of priority from Japanese Patent Application No. 2014-265004 filed on Dec. 26, 2014; the entire contents of all of which are incorporated herein by reference.

### FIELD

Embodiments of the present invention relate to an optical filter and an imaging apparatus.

### BACKGROUND

In an imaging apparatus using a solid-state image sensing device such as a Charge Coupled Device (CCD) or a Complementary Metal Oxide Semiconductor (CMOS) image sensor, an optical filter having various optical functions is arranged, for example, between an imaging lens and the solid-state image sensing device, or the like, so as to successfully reproduce a color tone and obtain a clear image. Further, in the imaging apparatus, a shielding member that is a so-called diaphragm is arranged to adjust an amount of light incident thereon to prevent a situation that the image sensing device cannot perform imaging because of saturation of electric charges generated due to light reception, or to cut stray light due to reflection or scattering from an optical member such as a lens or a sensor, a holding member therefor, and so on in the imaging apparatus.

In order to realize downsizing of such an imaging apparatus, there is proposed an imaging apparatus in which a black coating functioning as a diaphragm is integrally provided with an optical filter, for example, in the patent document JP-A 2002-268120. In the imaging apparatus, a space for arranging the diaphragm is unnecessary, which enables to downsize the apparatus, and in addition to that, the number of parts can be reduced and an assembly process can also be simplified.

Incidentally, an antireflection film which suppresses stray light due to refection of incident light and the like, is provided on an optical functional surface of an optical member such as an optical filter or a lens arranged in an imaging apparatus. The antireflection film is generally composed of a multilayered film formed by alternately stacking a low refractive index layer and a high refractive index layer through vapor deposition, sputtering, or the like, and the aforementioned black coating (light shielding film) is also desired to have such a reflection suppressing function.

However, a formation process of the aforementioned antireflection film is complicated, and thus there are problems in terms of productivity and cost. Further, also in terms of reflection suppressing effect, there is a problem that the effect easily varies since that of the aforementioned antireflection film generally has a wavelength dependency and an incident angle dependency.

Regarding such problems, for example, in the patent document WO 2013/061990 A1, it is described that a fine uneven (concavity/convexity) structure which suppresses reflection of light provided on a surface of a light shielding film that is integrally formed with an optical filter body, enables to obtain a reflection suppressing effect with no variation, particularly, a suppressing effect of regular reflection, without performing a complicated process.

However, in the optical filter described in Patent Reference 2, the fine uneven structure is provided only on a side, opposite to a side of the optical filter body, of the light shielding film, so that a position at which stray light is reflected is limited. Concretely, the fine uneven structure is provided on a surface closest to a subject side or a surface closest to a solid-state image sensing device side. As a result of this, there is a problem that the stray light cannot be sufficiently reduced due to multiple reflection and the like, depending on a mounting position.

Further, in the optical filter, the fine uneven structure is exposed to a surface, and a medium which is brought into contact with the fine uneven structure is air (refractive index≈1). For this reason, a degree of freedom of a refractive index difference (Δn) between a material of the light shielding film and the air is limited, and accordingly, a specification of the fine uneven structure required to suppress reflection, based on the refractive index difference, is also limited. Therefore, there is also a problem that it is difficult to further reduce the stray light.

### SUMMARY

An object of the present invention is to provide an optical filter integrally provided with a light shielding film capable of increasing a degree of freedom of a position of a fine uneven structure and a degree of freedom of a design of the fine uneven structure, and capable of further reducing stray light because of this, when it is mounted on an imaging apparatus, and a high-quality and high-performance imaging apparatus provided with the optical filter.

One aspect of the present invention is an optical filter used for an imaging apparatus having a built-in image sensing device on which light from a subject or a light source is incident, the optical filter including an optical filter body arranged between the subject or the light source and the image sensing device, and having a transmission property for the incident light, and a light shielding film arranged on at least one surface of the optical filter body, having a predetermined pattern shape, and shielding a part of the incident light, in which the optical filter body has a transparent substrate, and a first fine uneven structure suppressing reflection of light is provided on at least one interface between the transparent substrate and the light shielding film.

An imaging apparatus according to another aspect of the present invention include an image sensing device receiving light from a subject or a light source, a lens arranged between the subject or the light source and the image sensing device, and the aforementioned optical filter arranged between the subject or the light source and the image sensing device.

According to the present invention, an optical filter integrally provided with a light shielding film capable of increasing a degree of freedom of a position of a fine uneven structure and a degree of freedom of a design of the fine uneven structure, and capable of further reducing stray light because of this, is provided when it is mounted on an imaging apparatus. Further, according to the present invention a high-quality and high-performance imaging apparatus having the optical filter is provided.

### BRIEF DESCRIPTION OF THE DRAWINGS

FIG. 1 is a sectional view schematically illustrating an optical filter of a first embodiment.

FIG. 2 is a sectional view schematically illustrating a modified example of the optical filter of the first embodiment.

FIG. 3 is a sectional view schematically illustrating another modified example of the optical filter of the first embodiment.

FIG. 4 is a sectional view schematically illustrating another modified example of the optical filter of the first embodiment.

FIG. 5 is a sectional view schematically illustrating another modified example of the optical filter of the first embodiment.

FIGS. 6A to 6E are sectional views illustrating one example of a manufacturing method of the optical filter illustrated in FIG. 1.

FIGS. 7A to 7E are sectional views illustrating one example of a manufacturing method of the optical filter illustrated in FIG. 4.

FIGS. 8A and 8B are graphs illustrating results of simulation performed for examining a reflection suppressing effect of a first fine uneven structure.

FIGS. 9A and 9B are graphs illustrating results of another simulation performed for examining a reflection suppressing effect of the first fine uneven structure.

FIG. 10 is a diagram for explaining the simulation results illustrated in FIGS. 8A, 8B, 9A and 9B.

FIG. 11 is a plan view of the optical filter illustrated in FIG. 1.

FIG. 12 is a plan view illustrating a modified example of the first embodiment.

FIG. 13 is a sectional view schematically illustrating an optical filter of a second embodiment.

FIG. 14 is a sectional view schematically illustrating an optical filter of a third embodiment.

FIGS. 15A to 15E are sectional views illustrating one example of a manufacturing method of the optical filter illustrated in FIG. 14.

FIG. 16 is a sectional view schematically illustrating an imaging apparatus of a fourth embodiment.

FIG. 17 is a sectional view illustrating a modified example of the imaging apparatus of the fourth embodiment.

FIG. 18 is a graph illustrating a reflectance curve measured regarding an optical filter of Example.

### DETAILED DESCRIPTION

### First Embodiment

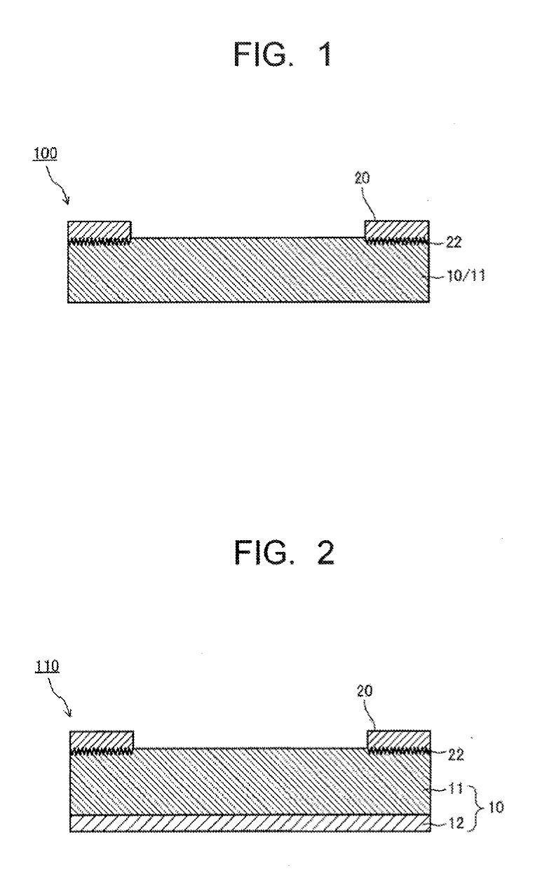

FIG. 1 is a sectional view schematically illustrating an optical filter of a first embodiment of the present invention.

As illustrated in FIG. 1, an optical filter 100 of the present embodiment includes an optical filter body (which is also simply referred to as a “filter body”, hereinafter) 10, and a light shielding film 20. The light shielding film 20 is integrally provided with an outer peripheral portion of one principal surface of the filter body 10.

The filter body 10 includes a transparent substrate 11. The transparent substrate 11 is made of a material having a transmission property for incident light to be described later. Note that it is also possible that the transparent substrate 11 itself also has a filter function such that it makes light with a specific wavelength transmit therethrough and shields light with a wavelength other than the specific wavelength.

Further, the light shielding film 20 is a film having a light shielding property with respect to incident light. As a material of which the light shielding film 20 is made, a light shielding resin containing an inorganic or organic coloring agent such as carbon black or titanium black, can be exemplified and the film is provided on one principal surface of the transparent substrate 11. Although the illustration is omitted, the light shielding film may also be provided on both principal surfaces of the transparent substrate 11. A kind of the resin is not particularly limited, and any of a light curing resin which is cured by being irradiated with light in an ultraviolet wavelength region or the like, a thermoplastic resin and a thermosetting resin, is usable. Note that the “light shielding property” in this case means a property of shielding transmission of light by mainly light absorption. The light shielding film 20 including such a light shielding resin functions as a so-called diaphragm which adjusts an amount of light received by an image sensing device or cuts stray light, when the optical filter 100 of the present embodiment is used in an imaging apparatus having a built-in image sensing device to be described later.

In this optical filter 100, a first fine uneven structure 22 which exhibits a light reflection suppressing function, is provided on an interface between the transparent substrate 11 and the light shielding film 20.

In order to obtain an excellent reflection suppressing effect, the first fine uneven structure 22 preferably has a structure such that a surface roughness thereof is 0.03 μm or more in terms of an arithmetic average roughness (Ra) measured by an atomic force microscope (AFM) in conformity with JIS B0601 (1994).

A more preferable range of the arithmetic average roughness (Ra) is 0.05 to 10 μm, further more preferably 0.1 to 2 μm, and much more preferably 0.2 to 0.5 μm.

In order to obtain the excellent reflection suppressing effect, the first fine uneven structure 22 preferably has a maximum height (Ry) measured in conformity with JIS B0601 (1994) of 0.1 μm or more. A more preferable range of the maximum height (Ry) is 3 to 9 μm, and still more preferably 4 to 6 μm. Further, an average interval (S) between local peaks measured by an ultra-deep profile measurement microscope in conformity with JIS B0601 (1994) is preferably 5.5 times or less of the maximum height (Ry). The average interval (S) is preferably within a range of 3.8 times or less of the maximum height (Ry), still more preferably within a range of 2.4 times or less, and further more preferably within a range of 1.2 times or less.

Further, the first fine uneven structure 22 has a convex portion whose height exceeds 100 nm, and a rising angle of the convex portion is preferably 20° or more, more preferably 40° or more, and still more preferably 60° or more. When the rising angle of the convex portion whose height exceeds 100 nm is less than 20°, a diffuse reflection performance deteriorates, resulting in that a component close to regular reflection increases. Here, the “rising angle of the convex portion” indicates an average value of angles each of which is an angle of a slope from a bottom point to an adjacent vertex, in a least square plane. Specifically, a plurality of angles are obtained by a plurality of bottom points and a plurality of vertices, and a value as a result of averaging these angles corresponds to the “rising angle of the convex portion”.

Note that the first fine uneven structure 22 can be formed by performing sandblasting on a surface of the transparent substrate 11 or the like, for example, as will be described later, in which by appropriately selecting a polishing material and a treatment condition used at the time of performing the sandblasting, it is possible to obtain a uneven structure having the above-described shape.

Further, a refractive index difference (Δn) of materials forming an interface on which the first fine uneven structure 22 is formed (in the example of FIG. 1, a refractive index difference (Δn) between the light shielding film 20 and the transparent substrate 11) is preferably 0.60 or less. When the refractive index difference (Δn) exceeds 0.60, regular reflection or diffuse reflection is likely to increase so that a sufficient reflection suppressing effect cannot be achieved, depending on a size, a shape, and the like of unevenness of the first fine uneven structure 22. The refractive index difference (Δn) is more preferably 0.30 or less, and still more preferably 0.10 or less.

The optical filter 100 of the present embodiment has the filter body 10 including the transparent substrate 11, the light shielding film 20 having a diaphragm function and provided to the filter body 10, and the first fine uneven structure 22 suppressing the reflection of light and provided on the interface between the filter body 10 and the light shielding film 20. Therefore, when compared to a conventional optical filter having a fine uneven structure only on an exposed surface of a light shielding film, namely, a principal surface of the light shielding film on a side opposite to a filter body 10 side, it is possible to increase a degree of freedom of a position of the fine uneven structure when the optical filter is mounted on an imaging apparatus. Further, in the conventional optical filter, a medium which is brought into contact with the fine uneven structure is air (refractive index≈1), so that a degree of freedom of a refractive index difference (Δn) between a material of the light shielding film and the air is limited, and accordingly, a specification of the fine uneven structure required to suppress reflection, based on the refractive index difference, is also limited. However, since the optical filter of the present embodiment has the fine uneven structure on the interface between the transparent substrate and the light shielding film, the degree of freedom of the refractive index difference (Δn) increases, resulting in that the degree of freedom of the specification of the fine uneven structure can also be increased. Consequently, it is possible to reduce stray light more considerably and more securely.

Note that in the present embodiment, the filter body 10 may also have at least one layer of optical functional layer, on at least one principal surface of the transparent substrate 11. As the optical functional layer, there can be cited an ultraviolet/infrared light reflective film composed of a dielectric multilayered film that transmits light in the visible wavelength region (referred to as “visible light”, hereinafter) and reflects light in the ultraviolet wavelength region (referred to as “ultraviolet light”, hereinafter) and/or light in the infrared wavelength region (referred to as “infrared light”, hereinafter), a light absorption film comprised of a transparent resin and an absorbent which absorbs light in a specific wavelength region (for example, an ultraviolet/infrared light absorption film made of a transparent resin containing an ultraviolet/infrared absorbent which absorbs the ultraviolet light and/or the infrared light, or the like), and an antireflection film, or the like. Further, as described above, the transparent substrate 11 itself may also have the filter function such that it makes light with a specific wavelength transmit therethrough and shields light with a wavelength other than the specific wavelength. In that case, it is possible to use the transparent substrate made of the resin containing the absorbent as indicated above, a near-infrared absorbing glass, or the like, for example.

FIGS. 2 to 4 are sectional views schematically illustrating examples of the above-described embodiment.

An optical filter 110 illustrated in FIG. 2 is an example in which of an antireflection film 12 is provided on one surface of the transparent substrate 11.

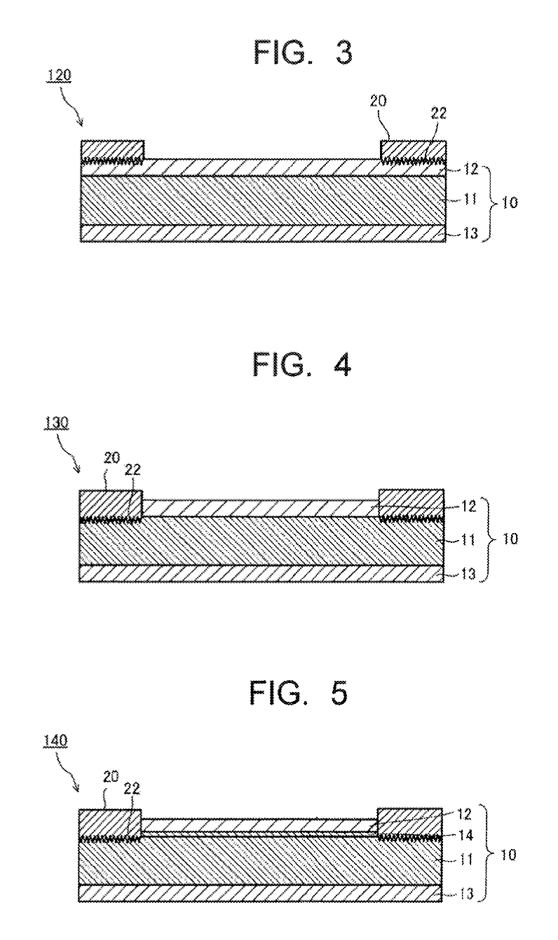

An optical filter 120 illustrated in FIG. 3 is an example in which the antireflection film 12 is provided on one surface of the transparent substrate 11, and an ultraviolet and infrared light reflective film 13 composed of a dielectric multilayered film which transmits the visible light and reflects the ultraviolet light and the infrared light, on the other surface of the transparent substrate 11. In this example, the light shielding film 20 is provided on a surface of the antireflection film 12, and the first fine uneven structure 22 is provided on an interface between the light shielding film 20 and the antireflection film 12. The light shielding film 20 may also be provided on a surface of the ultraviolet and infrared light reflective film 13, and it may also be provided on both surfaces of the antireflection film 12 and the ultraviolet and infrared light reflective film 13.

An optical filter 130 illustrated in FIG. 4 is an example in which the antireflection film 12 is provided on a part, namely, a portion except for an outer peripheral portion (a center portion) of one surface of the transparent substrate 11, so that the film is brought into contact with an end face on the inside of the outer peripheral portion, and the ultraviolet and infrared light reflective film 13 is provided on the other surface of the transparent substrate 11, similarly to the example of FIG. 3. Further, the light shielding film 20 is provided on a surface of the transparent substrate 11 on the antireflection film 12 side, and the first fine uneven structure 22 is provided on an interface between the light shielding film 20 and the transparent substrate 11. Note that also in this example, the light shielding film 20 may also be provided on a surface of the transparent substrate 11 on the ultraviolet and infrared light reflective film 13 side, and it may also be provided on both of the surface of the transparent substrate 11 on the ultraviolet and infrared light reflective film 13 side and the surface of the transparent substrate 11 on the antireflection film 12 side.

An optical filter 140 illustrated in FIG. 5 is an example in which a light absorption film 14 made of a transparent resin containing an absorbent which absorbs a specific wavelength and the antireflection film 12 is provided on a center portion except for an outer peripheral portion of one surface of the transparent substrate 11, so that the films are brought into contact with an end face on the inside of the outer peripheral portion, and the ultraviolet and infrared light reflective film 13 is provided on the other surface of the transparent substrate 11. Further, the light shielding film 20 is provided on a surface of the transparent substrate 11 on the side of the light absorption film 14 and the antireflection film 12, and the first fine uneven structure 22 is provided on an interface between the light shielding film 20 and the transparent substrate 11. The light absorption film 14 may be made of a transparent resin containing an ultraviolet/infrared absorbent which absorbs the ultraviolet light and/or the infrared light, for example, but, it may also be made of a transparent resin containing an absorbent which absorbs a wavelength other than the above. Also in this example, the light shielding film 20 may also be provided on the surface of the transparent substrate 11 on the ultraviolet and infrared light reflective film 13 side, and it may also be provided on both of the surface of the transparent substrate 11 on the ultraviolet and infrared light reflective film 13 side and the surface of the transparent substrate 11 on the side of the light absorption film 14 and the antireflection film 12.

Further, although the illustration is omitted, when the filter body 10 has at least one layer of optical functional layer on at least one principal surface of the transparent substrate 11, the first fine uneven structure 22 is only required to be provided on at least one interface between the transparent substrate 11 and the light shielding film 20. Therefore, for example, when the antireflection film 12 is provided on one surface of the transparent substrate 11 and the ultraviolet and infrared light reflective film 13 is provided on the other surface of the transparent substrate 11, as in the optical filter 120 of FIG. 3, the first fine uneven structure 22 is only required to be provided on at least one among an interface between the light shielding film 20 and the antireflection film 12, an interface between the antireflection film 12 and the transparent substrate 11, and an interface between the light shielding film 20 and the ultraviolet and infrared light reflective film 13.

In each of these examples, it is possible to increase not only a degree of freedom of a position of the fine uneven structure depending on a position at which the optical filter is mounted on an imaging apparatus, but also a degree of freedom of a specification of the fine uneven structure required for the antireflection, when compared to the conventional optical filter in which the fine uneven structure is provided on the exposed surface of the light shielding film, and accordingly, it is possible to further reduce stray light, when compared to the conventional optical filter.

In addition to that, since the fine uneven structure is not exposed to the surface, rubbing resistance (abrasion resistance) of the fine uneven structure is also improved.

Next, a manufacturing method (example) of the optical filter of the present embodiment will be described.

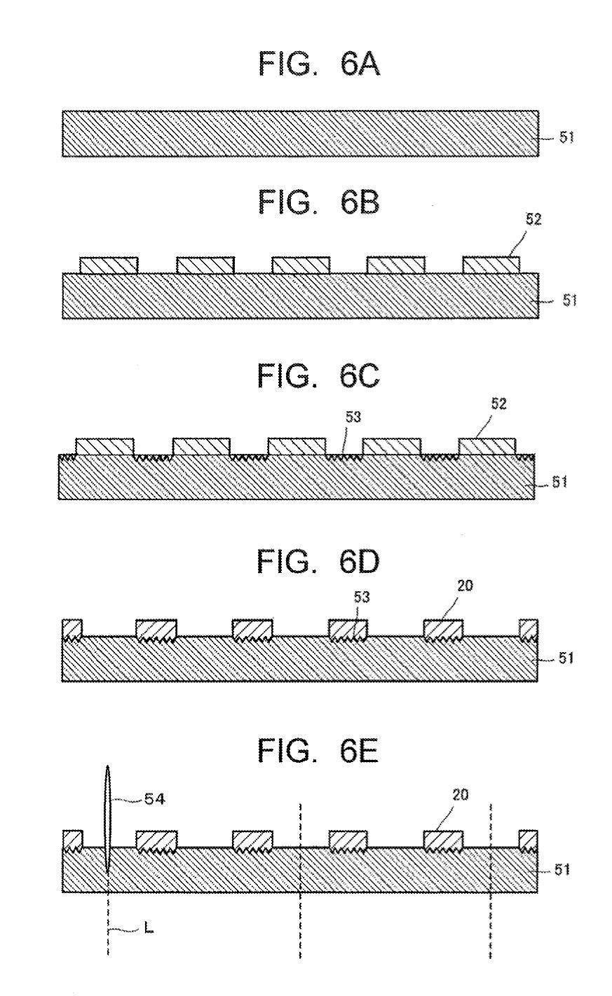

FIGS. 6A to 6E are sectional views schematically illustrating a manufacturing process of the optical filter 100 in which the light shielding film 20 is provided to an outer peripheral portion of one principal surface of the transparent substrate 11 which forms the filter body, and the first fine uneven structure 22 is formed on an interface between the transparent substrate 11 and the light shielding film 20.

First, a glass plate 51, for example to be the transparent substrate 11 is prepared (FIG. 6A), and on one surface thereof a resist layer 52 opening a light shielding film forming portion, is formed by a photolithography method (FIG. 6B). The resist layer 52 is only required to function as a mask when performing subsequent sandblasting, and it is possible to use, for example, a positive-type or negative-type liquid resist, a film resist (so-called dry film) or the like. Next, by using the resist layer 52 as a mask, the sandblasting is performed on the surface of the glass plate 51, to thereby form a fine uneven structure 53 (FIG. 6C).

After removing the resist layer 52, through screen printing via a screen mask (not illustrated) opening a position corresponding to that of the light shielding film 20, a resin having a light shielding property is coated and cured, to thereby form the light shielding film 20 (FIG. 6D).

After that, the glass plate 51 is cut in a thickness direction along a dicing line L to be separated into pieces, by using a dicing apparatus 54 (FIG. 6E). Consequently, there is obtained the optical filter 100 illustrated in FIG. 1 in which the light shielding film 20 is integrated with the outer peripheral portion of one principal surface of the transparent substrate 11, and the first fine uneven structure 22 is provided on the interface between the transparent substrate 11 and the light shielding film 20.

Note that the optical filters 110, 120 exemplified in FIG. 2 and FIG. 3 can be produced through a process similar to that described above, by employing a configuration in which the transparent substrate 11 having the antireflection film 12 formed on one surface thereof is used instead of the glass plate 51 in FIGS. 6A to 6E (example of FIG. 2), or by employing a configuration in which the transparent substrate 11 having the antireflection film 12 formed on one surface thereof and having the ultraviolet and infrared light reflective film 13 formed on the other surface thereof is used instead of the glass plate 51 in FIGS. 6A to 6E (example of FIG. 3).

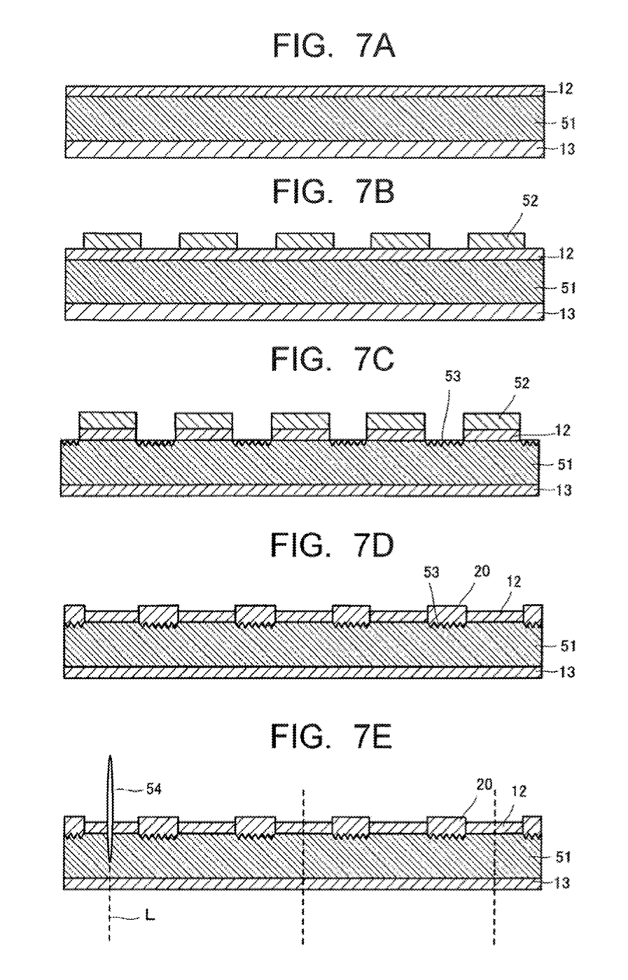

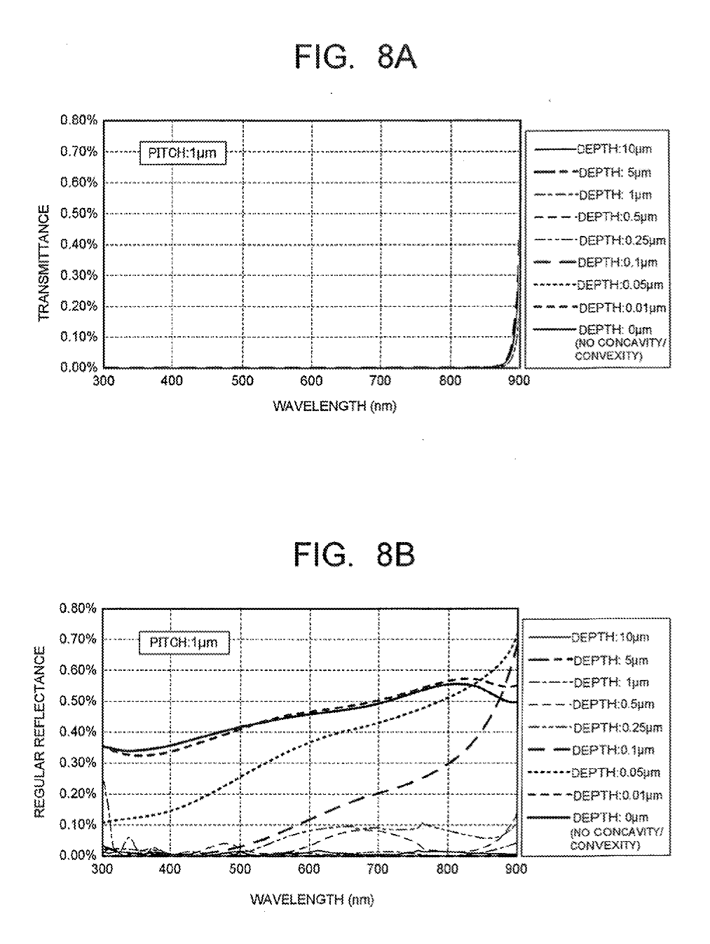

Further, the optical filter 130 exemplified in FIG. 4 can be produced through a process illustrated in FIGS. 7A to 7E.

FIGS. 7A to 7E are sectional views illustrating a manufacturing process of the optical filter 130 illustrated in FIG. 4.

In this example, first, the transparent substrate 11, for example, the glass plate 51, having the antireflection film 12 formed on one surface thereof and having the ultraviolet and infrared light reflective film 13 formed on the other surface thereof, is prepared (FIG. 7A). Next, on a surface of the antireflection film 12, the resist layer 52 opening the light shielding film forming portion, is formed by the photolithography method (FIG. 7B). By using the resist layer 52 as a mask, the sandblasting is performed on surfaces of the antireflection film 12 and the glass plate 51, to thereby form the fine uneven structure 53 (FIG. 7C).

After removing the resist layer 52, through screen printing via a screen mask (not illustrated) opening a position corresponding to that of the light shielding film 20, a resin having a light shielding property is coated and cured, to thereby form the light shielding film 20 (FIG. 7D).

After that, the antireflection film 12, the glass plate 51, and the ultraviolet and infrared light reflective film 13 are cut in a thickness direction along a dicing line L to be separated into pieces, by using the dicing apparatus 54 (FIG. 7E). Consequently, it is possible to produce the optical filter 130 illustrated in FIG. 4.

The optical filter 140 exemplified in FIG. 5 can be produced through a process similar to that described above, by employing a configuration in which the transparent substrate 11 having the light absorption film 14 formed on one surface thereof is used instead of the glass plate 51 in FIG. 7A to 7E.

A forming method of the light shielding film 20 is not limited to the above-described screen printing method, and it is also possible to employ a printing method other than the screen printing method, such as a flexographic printing method. Further, it is also possible that a semi-cured resin film or a cured resin film having a light shielding property and previously formed in a predetermined pattern shape, is adhered to a surface of the transparent substrate 11 or the like after removing the resist layer 52, using an adhesive, to thereby form the light shielding film 20. Further, when a light curing resin is used, it is also possible to use methods as follows.

Specifically, a light curing resin having a light shielding property is applied to the entire surface of the transparent substrate 11 or the like after removing the resist layer 52, and dried to form a light curing resin coated layer. As a coating method of the light curing resin, a spin coating method, a bar coating method, a dip coating method, a casting method, a spray coating method, a bead coating method, a wire bar coating method, a blade coating method, a miler coating method, a curtain coating method, a slit die coating method, a gravure coating method, a slit reverse coating method, a micro gravure method, a comma coating method and so on can be used. The coating may be performed dividedly in a plurality of times. Further, prior to the coating, a coupling treatment using hexamethyldisilazane (HMDS) or the like may be performed on the coating surface, in order to enhance the adhesiveness to the transparent substrate 11 or the like.

Next, light is irradiated to the light curing resin coated layer via a photomask in which an opening is made at a position corresponding to the light shielding film. As for the light to be irradiated, for example, when the light curing resin is cured by ultraviolet light, light containing at least such ultraviolet light is irradiated. Consequently, the light curing resin at a portion irradiated with the light is cured.

Then, the light curing resin at an un-irradiated portion is selectively removed by development, to thereby form the light shielding film. For the development, wet development, dry development or the like may be used. When the wet development is used, it is possible to apply a dip method, a spray method, brushing, slapping or the like, by using a developing solution corresponding to the kind of the light curing resin, such as an alkaline solution, an aqueous developing solution, or an organic solvent.

Thickness of the light shielding film formed by the method as described above, is preferably in a range of 1 to 30 μm, more preferably in a range of 1 to 20 μm, still more preferably in a range of 1 to 10 μm, and further more preferably in a range of 3 to 10 μm, from a viewpoint of downsizing of an imaging apparatus and light shielding property. When the thickness of the light shielding film is less than 1 μm, sufficient light shielding property may not be achieved, and on the other hand, when the thickness of the light shielding film exceeds 30 μm, the downsizing of the imaging apparatus may not be realized.

Next, a concrete cross-sectional shape of the first fine uneven structure will be described.

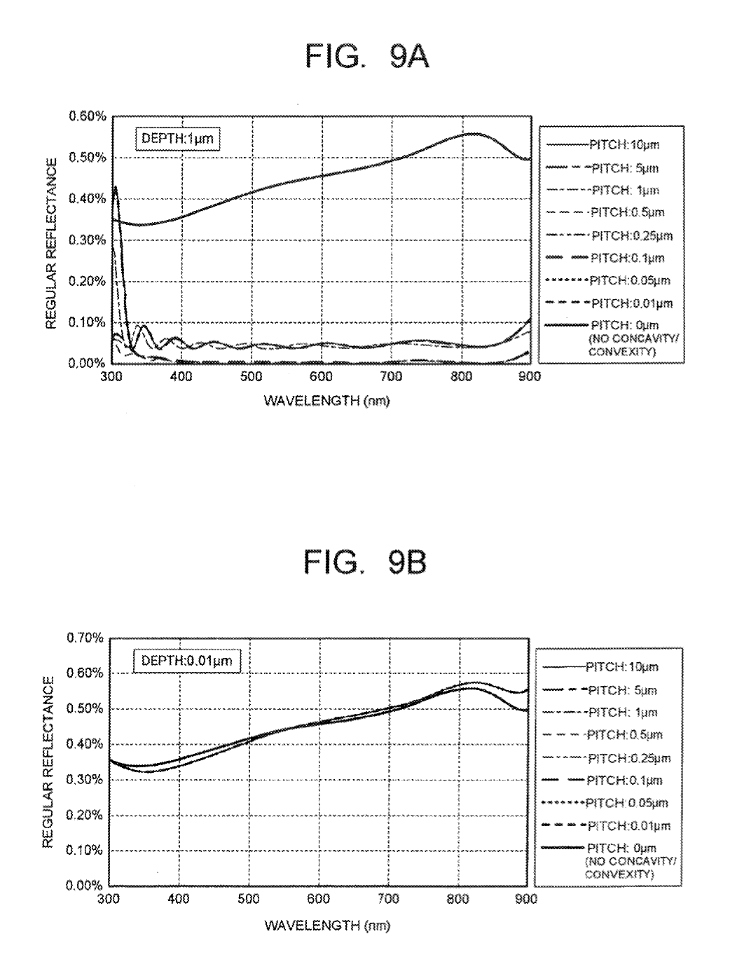

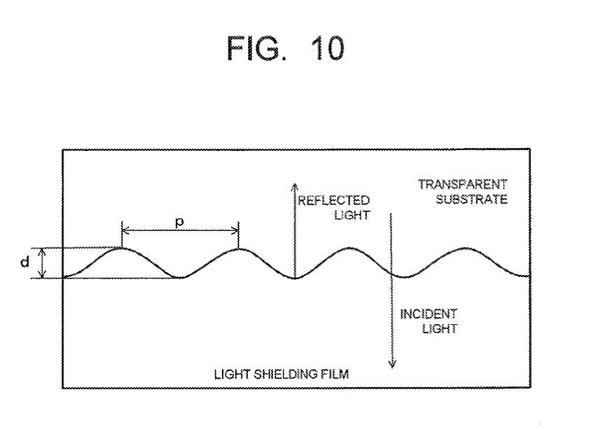

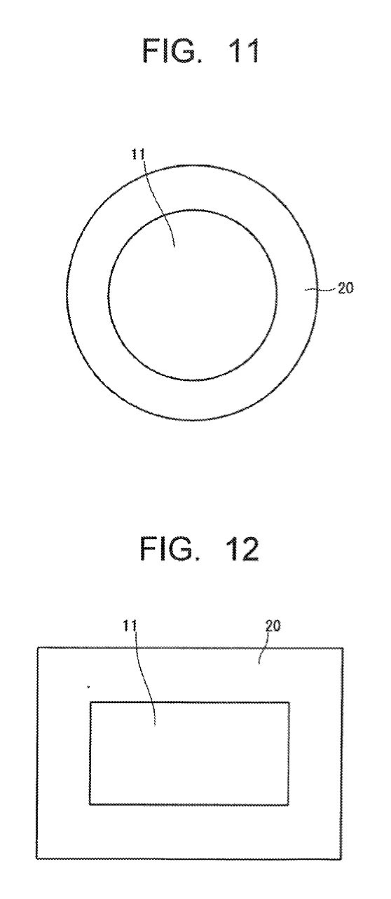

FIGS. 8A, 8B, 9A and 9B illustrate simulation results obtained by examining a reflection suppressing effect brought by a concavity/convexity shape (a depth (d) and a pitch (p)) of the first fine uneven structure, when the light shielding film has a thickness capable of obtaining sufficient light shielding property. In the simulation, it is assumed that a concavity/convexity in a shape of sine square curve illustrated in FIG. 10 is formed on an interface between the transparent substrate 11 and the light shielding film 20, and a spectral transmittance and a regular reflectance of light (with a wavelength of 300 to 900 nm) incident from the inside of the transparent substrate 11 at the interface between the transparent substrate and the light shielding film are calculated. FIGS. 8A and 8B illustrate a spectral transmittance (FIG. 8A) and a regular reflectance (FIG. 8B) a pitch (p) corresponding to a width between adjacent vertices being fixed to 1 μm and a depth (d) being changed from 0 μm (no concavity/convexity) to 10 μm. Further, FIG. 9A illustrates a regular reflectance, a depth (d) being fixed to 1 μm and a pitch (p) being changed from 0 μm (no concavity/convexity) to 10 μm, and FIG. 9B illustrates a regular reflectance, a depth (d) being fixed to 0.01 μm and a pitch (p) being changed from 0 μm (no concavity/convexity) to 10 μm.

Based on FIG. 8A, the transmittance of light with a wavelength of 300 to 870 nm is approximately 0%, regardless of the presence/absence of the concavity/convexity. Further, based on FIG. 8B, under the condition where the pitch (p) is 1 μm, the reflection suppressing effect brought by the concavity/convexity is recognized when the depth (d) is 0.05 μm or more, the regular reflectance of light with a wavelength of 400 to 800 nm is 0.30% or less when the depth (d) is 0.1 μm or more, and the regular reflectance of light in a substantially entire wavelength region of 300 to 900 nm is 0.10% or less when the depth (d) is 0.25 μm or more.

Based on FIG. 9A, under the condition where the depth (d) is 1 pun, when there is provided the pitch (p) (specifically, except for a case where the pitch (p)=0), the reflectance of light in an entire wavelength region of 350 to 900 nm is approximately 0%. Further, based on FIG. 9B, under the condition where the depth (d) is 0.01 μm, the reflection suppressing effect brought by the concavity/convexity is not recognized regardless of the pitch (p).

The above simulation results indicate that a large influence due to the depth (d) is exerted on the reflection suppressing effect, and in order to obtain a good antireflection effect, the depth (d) is preferably 0.1 μm (corresponding to 31.85 nm in terms of arithmetic average roughness (Ra)) or more, and more preferably 0.25 μm (corresponding to 79.6 nm in terms of arithmetic average roughness (Ra)) or more.

FIG. 11 is a plan view of the optical filter 100 of the present embodiment seen from the light shielding film 20 side. As illustrated in FIG. 11, in the present embodiment, a planar shape of the filter body 10 is a circular shape, and the light shielding film 20 made of a resin is annularly provided along an outer periphery of the filter body 10. Note that the planar shape of the filter body 10 may also be a rectangular shape as illustrated in FIG. 12, for example, and is not particularly limited.

Hereinafter, the transparent substrate, the ultraviolet and infrared light reflective film, the antireflection film, and the ultraviolet/infrared light absorption film, which constitute the optical filter of the present embodiment and a modified example thereof, will be described in detail.

A shape of the transparent substrate is not particularly limited as long as it transmits visible light, and as examples thereof, there can be cited a plate shape, a film shape, a block shape, a lens shape and so on. Further, as described above, the transparent substrate may be made of infrared absorbing glass or a resin containing an infrared absorbent.

Examples of the material of the transparent substrate include a glass, crystals such as crystalline quartz, lithium niobate, and sapphire, polyester resins such as polyethylene terephthalate and polybutylene terephthalate, polyolefin resins such as polyethylene, polypropylene, and ethylene-vinyl acetate copolymer, a norbornene resin, acrylic resins such as polyacrylate and polymethyl methacrylate, a urethane resin, a vinyl chloride resin, a fluorocarbon resin, a polycarbonate resin, a polyvinyl butyral resin, a polyvinyl alcohol resin, and so on. These materials may have absorption characteristics for at least one of the ultraviolet wavelength region and the infrared wavelength region.

As the glass, one appropriately selected from materials which are transparent with respect to visible light can be used. For example, borosilicate glass is preferable because it is easily processed and it can suppress occurrence of scratch, foreign substance and the like on the optical surface, and glass containing no alkaline component is preferable because it has good adhesiveness, weather resistance and so on.

Further, light absorbing glass having absorption in the infrared wavelength region made by adding CuO or the like to fluorophosphate-based glass or phosphate-based glass can be used. In particular, the fluorophosphate-based glass or the phosphate-based glass having CuO added thereto has a high transmittance with respect to the visible light, sufficiently absorbs near-infrared light, and further, it can suppress variation of transmittance due to an incident angle of light, so that it can impart a good near-infrared cutting function.

As an example of the fluorophosphate-based glass containing CuO, the one containing 0.1 to 5 parts by mass, preferably 0.3 to 2 parts by mass of CuO with respect to 100 parts by mass of fluorophosphate-based glass composed of, by mass %, 46 to 70% of P₂O₅, 0 to 25% of MgF₂, 0 to 25% of CaF₂, 0 to 25% of SrF2, 0 to 20% of LiP, 0 to 10% of NaF, 0 to 10% of KF where a total amount of LiF, NaF, and KF is 1 to 30%, 0.2 to 20% of AlF₃, and 2 to 15% of ZnF₂ (where up to 50% of a total sum of fluoride can be substituted by oxide). Examples of a commercially available product include NF-50 (brand name, manufactured by ASAHI GLASS CO., LTD.) or the like.

As an example of the phosphate-based glass containing CuO, the one containing 0.1 to 5 parts by mass, preferably 0.3 to 2 parts by mass of CuO with respect to 100 parts by mass of phosphate-based glass composed of, by mass %, 70 to 85% of P₂O₅, 8 to 17% of Al₂O₃, 1 to 10% of B₂O₃, 0 to 3% of Li₂O, 0 to 5% of Na₂, 0 to 5% of K₂O, 0.1 to 5% of Li₂O+Na₂O+K₂O, and 0 to 3% of SiO₂ can be exemplified.

A thickness of the transparent substrate is not limited, but is preferably 0.1 to 3 mm, and more preferably 0.1 to 1 mm, from a viewpoint of reduction in size and weight.

The ultraviolet and infrared light reflective film 13 has a function of imparting or enhancing the ultraviolet and near-infrared cut filter function. The ultraviolet and infrared light reflective film 13 is composed of a dielectric multilayered film made by alternately stacking a low refractive index dielectric layer and a high refractive index dielectric layer by a sputtering method, a vacuum deposition method or the like.

The dielectric multilayered film can also be formed by an ion beam method, an ion plating method, a CVD method, or the like. The sputtering method and the ion plating method perform so-called plasma atmospheric treatment, so that it is possible to improve adhesiveness to the transparent substrate.

The antireflection film 12 suppresses reflection of light incident on the optical filter to improve the transmittance so as to efficiently utilize the incident light, and can be formed by well-known material and method. Specifically, the antireflection film 12 may be composed of a film of one or more layers of silica, titania, tantalum pentoxide, magnesium fluoride, zirconia, alumina, or the like formed by a sputtering method, a vacuum deposition method, an ion beam method, an ion plating method, a CVD method, or the like, or a film of silicate, silicone, methacrylate fluoride, or the like formed by a sol-gel method, a coating method, or the like. A thickness of the antireflection film 12 may be usually 100 to 600 nm.

The ultraviolet/infrared light absorption film is made of a transparent resin containing an ultraviolet/infrared absorbent which absorbs the ultraviolet light and/or the infrared light. The ultraviolet/infrared light absorption film may be provided between the transparent substrate 11 and the antireflection film 12 in each of the optical filters 110, 120, 130, and an optical filter 160 to be described later, for example. The above-described optical filter 140 exemplifies a case where the light absorption film 14 is provided between the transparent substrate 11 and the antireflection film 12 in the optical filter 130. Other than the above, the ultraviolet/infrared light absorption film may also be provided between the transparent substrate 11 and the ultraviolet and infrared light reflective film 13 in each of the optical filters 120, 130, and the optical filter 160 to be described later. Note that the ultraviolet/infrared light absorption film may also have a function of absorbing both of the ultraviolet light and the infrared light, as one light absorbing structure. Further, the ultraviolet/infrared light absorption film may also be configured as two light absorbing structures so that it includes a function of absorbing the ultraviolet light and a function of absorbing the infrared light, separately. When the ultraviolet/infrared light absorption film is configured as two light absorbing structures, arrangement of the respective absorbing structures can be arbitrarily set.

The transparent resin only needs to transmit the visible light, and as examples thereof, there can be cited an acrylic resin, a styrene resin, an ABS resin, an AS resin, a polycarbonate resin, a polyolefin resin, a polyvinyl chloride resin, an acetate-based resin, a cellulose-based resin, a polyester resin, an allyl ester resin, a polyimide resin, a polyamide resin, a polyimide ether resin, a polyamide-imide resin, an epoxy resin, a urethane resin, a urea resin and so on.

Further, as the ultraviolet/infrared absorbent which absorbs the ultraviolet light and/or the infrared light, there can be cited an organic or inorganic pigment, an organic dye, or the like, for example. One kind of the ultraviolet/infrared absorbent may be used alone or two or more kinds may be used by mixture.

The transparent resin may further contain, other than the ultraviolet/infrared absorbent, a color tone correcting dye, a leveling agent, an antistatic agent, a beat stabilizer, an antioxidant, a dispersing agent, a flame retardant, a lubricant, a plasticizer and so on in a range not inhibiting the effect of the present invention.

The ultraviolet/infrared light absorption film can be obtained, for example, by preparing a painting liquid by dispersing or dissolving the transparent resin, the ultraviolet/infrared absorbent, and other additives to be mixed as necessary into a dispersion medium or a solvent, and then painting and drying the mixture. The painting and drying can be performed dividedly in a plurality of times, and at that time, a plurality of painting liquids having different components may be prepared, and painted and dried in sequence.

Examples of the dispersion medium or solvent include water, alcohol, ketone, ether, ester, aldehyde, amine, aliphatic hydrocarbon, alicyclic hydrocarbon, aromatic hydrocarbon and so on. One kind of them may be used alone or two or more kinds may be used by mixture. To the painting liquid, a dispersing agent may be mixed as necessary.

For the preparation of the painting liquid, it is possible to use a stirring apparatus such as a planetary centrifugal mixer, a bead mill, a satellite mill, an ultrasonic homogenizer, or the like. It is preferable to sufficiently perform stirring for securing high transparency. The stirring may be performed continuously or intermittently.

Further, for painting the painting liquid, it is possible to employ a spin coating method, a bar coating method, a dip coating method, a casting method, a spray coating method, a bead coating method, a wire bar coating method, a blade coating method, a roller coating method, a curtain coating method, a slit die coating method, a gravure coating method, a slit reverse coating method, a micro gravure method, a comma costing method, and the like.

A thickness of the ultraviolet/infrared light absorption film is preferably in a range of 0.01 to 200 μm, and more preferably in a range of 0.1 to 50 μm. A thickness less than 0.01 μm may fail to obtain predetermined absorptivity. When a thickness exceeds 200 μm, uneven drying may occur, resulting in that desired optical characteristics may not be obtained.

### Second Embodiment

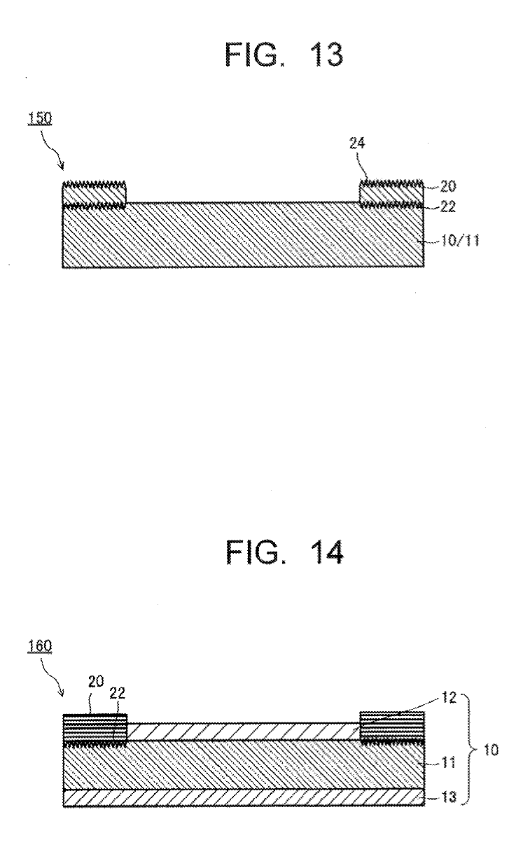

FIG. 13 is a schematic sectional view of an optical filter 150 according to a second embodiment of the present invention. In the present embodiment and thereafter, in order to avoid overlapped explanation, a point which is common to that of the first embodiment will be omitted, and a point of difference will be mainly explained.

As illustrated in FIG. 13, the optical filter 150 of the present embodiment has a structure in which a second fine uneven structure 24 having a reflection suppressing function of light, is formed on an exposed face of the light shielding film 20 in the first embodiment, namely, a surface of the light shielding film 20 on the opposite side of the transparent substrate 11.

The second fine uneven structure 24 preferably has a structure such that a surface roughness thereof is 0.1 μm or more in terms of the arithmetic average roughness (Ra) measured by the atomic force microscope (AFM) in conformity with JIS B0601 (1994). The arithmetic average roughness (Ra) is preferably 0.15 to 10 μm, more preferably 0.2 to 2 μm, and further more preferably 0.2 to 0.5 μm.

Further, the second fine uneven structure 24 preferably has an average interval (S) between local peaks measured by the ultra-deep profile measurement microscope in conformity with JIS B0601 (1994) of 1 to 100 μm, and it preferably has a maximum height (Ry) measured in conformity with JIS B0601 (1994) of 2 μm or more. The average interval (S) between local peaks is more preferably 2 to 50 μm, and much more preferably 5 to 20 μm. The maximum height (Ry) is more preferably 3 to 9 μm, and much more preferably 4 to 6 μm.

The optical filter 150 having the second fine uneven structure 24 can be obtained in a manner that the light shielding film is formed through the method described in the first embodiment, radiation is then applied to the light shielding film to cure only a surface layer portion of the light shielding film, and then heating is performed to relax stress generated by the application of radiation. A heating temperature is only required to be a temperature at which a portion except for the cured surface layer portion of the light shielding film is softened, and is usually about 50 to 300° C., and preferably about 150 to 220° C.

Further, the second fine uneven structure 24 can also be formed by performing dry etching treatment on the surface of the light shielding film. Although a method of the dry etching treatment is not limited, it is preferable to employ a reactive ion etching method in which oxygen gas (O₂), carbon tetrafluoride gas (CF₄), trifluoromethane (CHF₃), or a mixed gas of those is used as an etching gas, from a viewpoint of reflection suppressing effect, easiness of treatment, easiness of control, easiness of obtainment of the etching gas, and the like.

Further, the light shielding film can also be formed by using as its forming material, a light shielding resin containing a matting agent such as a silica fine particle.

Specifically, in the manufacturing method described in the first embodiment, a light curing resin, a thermoplastic resin, or a thermosetting resin with the light shielding property, in which the matting agent is contained together with an inorganic or organic coloring agent such as carbon black or titanium black, and to which a solvent or dispersion medium is mixed according to need, is coated on the surface of the glass plate or the like after removing the resist layer, in a pattern shape corresponding to the light shielding film, through the printing method such as the screen printing or the flexographic printing, or the like. Then, drying is performed to form a light shielding resin coated layer, and thereafter, the light shielding resin coated layer is cured by light irradiation or heating Consequently, the light shielding film 20 having the second fine uneven structure 24 is obtained.

As an example of the matting agent can be cited an inorganic fine particle of silica, alumina, titanium oxide, calcium carbonate, or the like. Further, it is also possible to use a fine particle made of a resin of divinylbenzene cross-linked polymer or the like. A content of the matting agent in the light shielding resin is usually in a range of 2 to 10 mass %, and preferably in a range of 2.5 to 8 mass %, based on the solid content, although depending on a type, a particle size, and the like of the matting agent. To the light shielding resin, other than the matting agent and the coloring agent, an additive for increasing adhesiveness, for example, a silane coupling agent or the like, may also be mixed.

According to the present embodiment, in addition to an effect similar to that of the first embodiment, an effect of enabling suppression of regular reflection at the interface of the light shielding film with respect to incident light incident on both of the front surface and the rear surface of the light shielding film, to thereby reduce stray light, can be obtained.

### Third Embodiment

FIG. 14 is a sectional view schematically illustrating of an optical filter 160 of a third embodiment of the present invention.

In the optical filter 160 of the present embodiment, a light shielding film 20 corresponds to that in the first embodiment is configured to have a multilayered film structure formed by alternately stacking an oxide dielectric film and a metal film. Note that FIG. 14 illustrates an example in which the light shielding film 20 of the optical filter 130 (FIG. 4) being the modified example of the first embodiment is configured to have a multilayered film formed by alternately stacking the oxide dielectric film and the metal film.

As the oxide dielectric film which is composed of the multilayered film, there can be cited a film made of SiO₂, Al₂O₃, or the like. As the metal film, there can be cited a single film made of a metal of Ni, Ti, Nb, Ta, Cr, or the like, an alloy having those metals as main components, or the like. Concretely, there can be cited a multilayered film configured by using Cr for the metal film and SiO₂ for the oxide dielectric film, or the like.

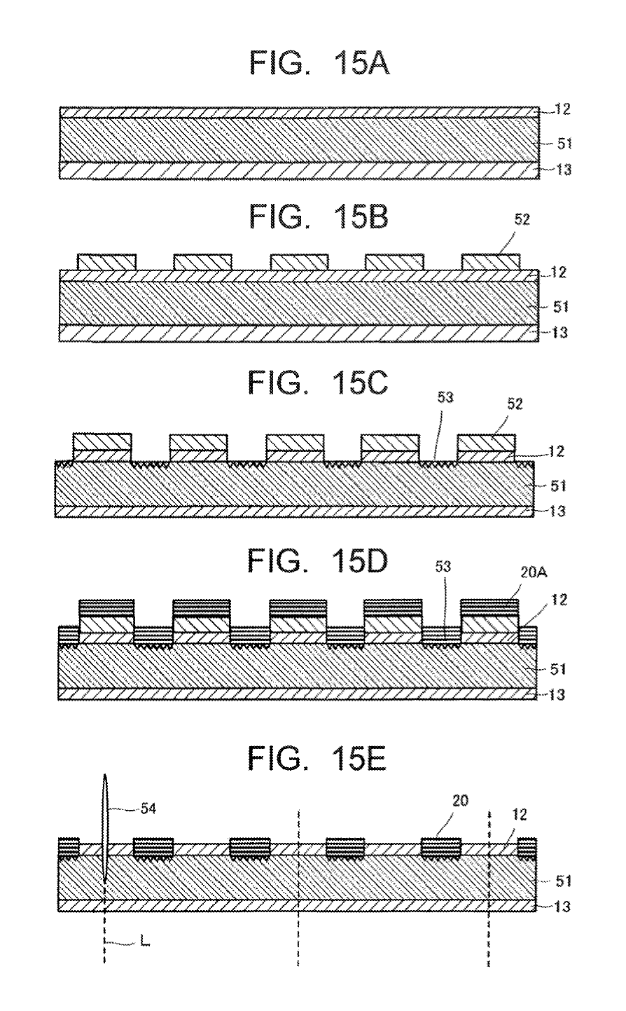

FIGS. 15A to 15E are sectional views illustrating a manufacturing process of the optical filter 160 illustrated in FIG. 14.

In this example, first, a transparent substrate material, for example, the glass plate 51, having the antireflection film 12 formed on one surface thereof, and having the ultraviolet and infrared light reflective film 13 formed on the other surface thereof is first prepared (FIG. 15A). Next, on a surface of the antireflection film 12, the resist layer 52 opening the light shielding film forming portion, is formed by the photolithography method (FIG. 15B). Then, by using the resist layer 52 as a mask, the sandblasting is performed on surfaces of the antireflection film 12 and the glass plate 51, to thereby form the fine uneven structure 53 (FIG. 15C).

Next, on the surfaces of them, a multilayered film 20A is formed by alternately stacking the oxide dielectric film and the metal film, through the sputtering method, the vacuum deposition method, or the like (FIG. 15D). For the formation of the multilayered film 20A, it is also possible to employ, other than the sputtering method and the vacuum deposition method, an ion beam method, an ion plating method, a CVD method, and the like. Thereafter, the resist layer is removed together with the multilayered film 20A formed on the resist layer, and then the antireflection film 12, the glass plate 51, and the ultraviolet and infrared light reflective film 13 are cut in a thickness direction along a dicing line L to be separated into pieces, by using the dicing apparatus 54 (FIG. 15E). Consequently, there is obtained the optical filter 160 illustrated in FIG. 14 in which the antireflection film 12 is firmed on one surface of the transparent substrate 11, the ultraviolet and infrared light reflective film 13 is formed on the other surface of the transparent substrate 11, the light shielding film 20 composed of the multilayered film is formed on the surface of the transparent substrate 11 on the antireflection film 12 side, and the first fine uneven structure 22 is formed on the interface between the light shielding film 20 and the transparent substrate 11.

Also in the present embodiment, it is possible to achieve an effect similar to that of the first embodiment described above, and in addition to that, since the light shielding film 20 is configured by the multilayered film formed by alternately stacking the oxide dielectric film and the metal film, it is possible to improve heat resistance when compared to the first embodiment and the second embodiment in which the light shielding film is made of the resin.

### Fourth Embodiment

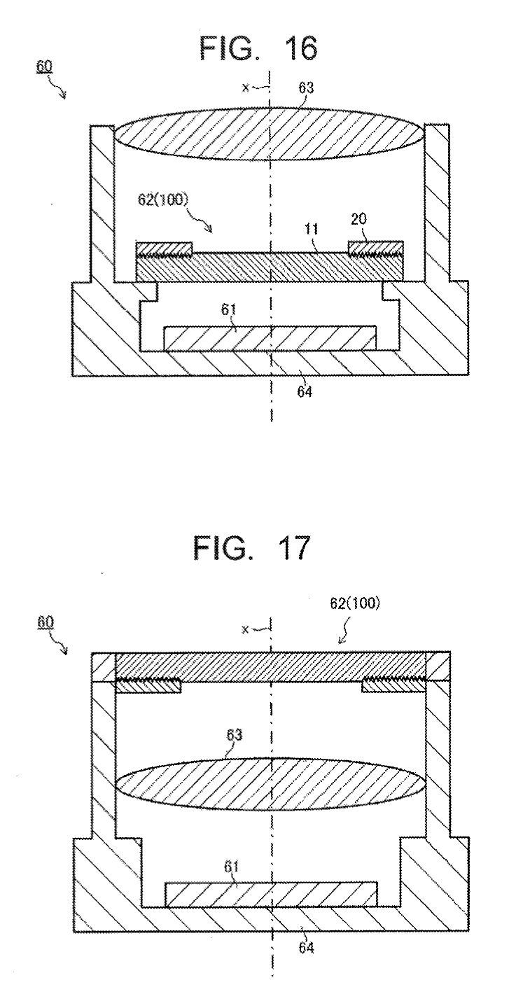

FIG. 16 is a sectional view schematically illustrating an imaging apparatus 60 according to a fourth embodiment.

As illustrated in FIG. 16, the imaging apparatus 60 of the present embodiment has a solid-state image sensing device 61, an optical filter 62, a lens 63, and a casing 64 which holds and fixes them.

The solid-state image sensing device 61, the optical filter 62, and the lens 63 are arranged along an optical axis x, and the optical filter 62 is arranged between the solid-state image sensing device 61 and the lens 63. The solid-state image sensing device 61 is an electronic component such as a CCD or a CMOS that converts light incident thereon after passing through the lens 63 and the optical filter 62 into an electric signal. In the present embodiment, the optical filter 100 illustrated in FIG. 1 is used as the optical filter 62, and is disposed so that the light shielding film 20 thereof is positioned on the lens 63 side. Note that the optical filter 100 may also be disposed so that the light shielding film 20 is positioned on the solid-state image sensing device 61 side. Further, in the present embodiment, the optical filter 100 in FIG. 1 is used as the optical filter 62, but, the respective optical filters illustrated in FIGS. 2 to 5, FIG. 13, FIG. 14, and the like can also be used.

In the imaging apparatus 60, the light incident from the subject side passes through the lens 63 and the optical filter 62 (100) to be received by the solid-state image sensing device 61. The received light is converted into an electric signal by the solid-state image sensing device 61, and output as an image signal. The incident light passes through the optical filter 100 having the light shielding film 20, and accordingly, it is received by the solid-state image sensing device 61 as light adjusted to have an adequate light amount.

In the imaging apparatus 60, the first fine uneven structure 22 which suppresses the reflection of light, is formed on the interface between the transparent substrate 11 and the light shielding film 20 of the optical filter 100. For this reason, when compared to the conventional optical filter in which the fine uneven structure is formed only on the exposed surface of the light shielding film, and the medium which is brought into contact with the fine uneven structure is limited to the air, the degree of freedom of the specification of the fine uneven structure required to suppress reflection increases. Consequently, it is possible to reduce stray light more considerably and more securely compared to the conventional optical filter. Specifically, when the interface with the light shielding film is the air, it is required to reduce a refractive index of the material of the light shielding film (to close to 1), in order to reduce a refractive index difference between the air and the light shielding film. However, the resin or the like capable of being used as the material of the light shielding film has the refractive index of about 1.3 at the lowest, and thus it is sometimes difficult to provide a sufficient reflection suppressing function. On the contrary, at the interface between the substrate and the light shielding film, the refractive index difference can be kept low also in a general material capable of being used for the substrate and the light shielding film, resulting in that the regular reflection at the interface can be kept low.

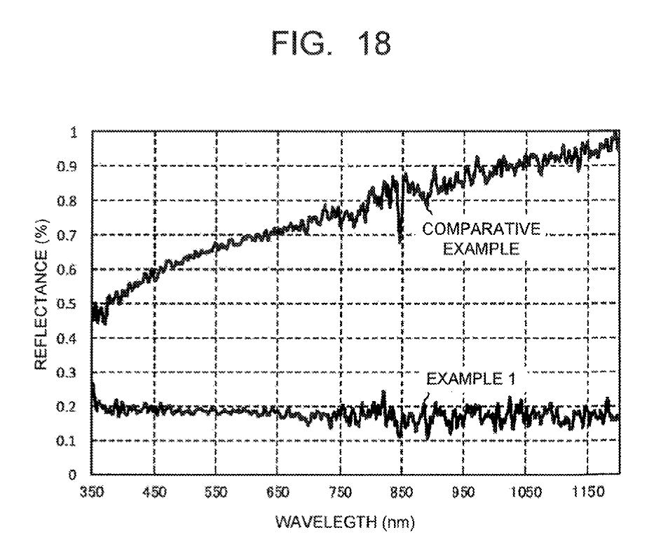

One lens is disposed in the imaging apparatus 60 according to the fourth embodiment, but, the apparatus may also include a plurality of lenses, and further, a cover glass or the like for protecting the solid-state image sensing device 61 may also be disposed in the apparatus. Further, the optical filter 100 is not limited to be positioned between the lens and the solid-state image sensing device, and the filter may be disposed further on the subject side relative to the lens 63 as illustrated in FIG. 17, for example, or when a plurality of lenses are arranged, the filter may be disposed between the lenses.

### EXAMPLES

### Example 1

A white glass plate in a square plate of 50 mm×50 mm×0.3 mm was prepared, and the sandblasting was performed on one surface of the white glass plate for 120 seconds to form a fine uneven structure.

A light shielding resin ink was coated on the fine uneven structure through the spin coating method, and heating was performed at 80° C. for 10 minutes, and subsequently performed at 120° C. for 60 minutes, to thereby form a light shielding film with a thickness of 20 μm. A refractive index difference Δn between the white glass plate and the light shielding film was confirmed to be less than 0.1 in a visible wavelength region from 400 to 700 nm.

Table 1 represents results of measuring an arithmetic average roughness (Ra), a maximum height (Ry), an average interval (S) between local peaks, and an average peak inclination of a fine uneven structure formed on an interface between the transparent substrate and the light shielding film of the obtained optical filter, by using a stylus-type level-difference meter Alpha-Step IQ manufactured by KLA-Tencor Corporation. The “average peak inclination” is an index corresponding to the aforementioned “rising angle of the convex portion”. The calculation was performed based on JIS B0601 (1994) and JIS B0031 (1994). In Table 1, Comparative Example is one of an optical filter produced in a similar manner to that of Example except that the sandblasting was not performed.

TABLE 1

| | | Arithmetic | | Average | |
|---|---|---|---|---|---|
| | | average | | interval | Average |
| | Blasting | rough- | Maximum | between | peak |
| | time | ness Ra | height Ry | local peaks | inclination |
| | (sec) | (nm) | (μm) | (μm) | (°) |
| Example | 120 | 1015.42 | 5.114 | 18.24 | 89.12 |
| Comparative | 0 | 3.71 | 0.011 | 2.62 | 51.26 |
| Example | | | | | |

### Example 2

A white glass plate having a size same as that of Example 1 was prepared, and an antireflection film was formed on one surface of the white glass plate and an ultraviolet and infrared light reflective film was formed on the other surface thereof. They were composed of a dielectric multilayered film formed through the vacuum deposition method.

Next, a positive-type photoresist was painted on the antireflection film to have a thickness of 4 μm, and then there was formed a pattern with which the photoresist remains only at a portion (center portion) except for an outer peripheral portion in which a light shielding film was formed. Subsequently, the face having the photoresist pattern was subjected to the sandblasting for 120 seconds, to thereby remove the antireflection film exposed to the outer peripheral portion and form a fine uneven structure on a surface (of the outer peripheral portion) of the white glass plate. After that, the remained photoresist (at the center portion) was removed by a resist stripping solution.

Next, a light shielding resin ink was selectively coated on the portion where the fine uneven structure was formed, via a screen mask, and heating was performed at 90° C. for 10 minutes, and subsequently performed at 150° C. for 60 minutes, to form a light shielding film with a thickness of 5 μm. Note that a refractive index difference Δn between the white glass plate and the light shielding film was confirmed to be less than 0.1 in a visible wavelength region from 400 to 700 nm.

In order to evaluate the respective optical filters obtained in the above-described Example 1 and Comparative Example, a regular reflectance was measured by using a spectrophotometer (UH4150 manufactured by Hitachi High-Technologies Corporation). FIG. 18 represents the results.

As can be seen from FIG. 18, by providing the fine structure, a regular reflectance of 0.63% (Comparative Example) being a measured value at a wavelength of 500 nm, is reduced to 0.18% (Example 1), and reduced to 0.20% (Example 2). FIG. 18 illustrates the result of Example 1 as a representative, but, a result similar to that of Example 1 can be achieved also in Example 2.

An optical filter of the present invention is significantly excellent in a stray light reducing effect, and is useful for an imaging apparatus such as a miniature camera mounted on information devices such as a digital still camera and a digital video camera.

What is claimed is:

1. An optical filter used for an imaging apparatus having a built-in image sensing device on which light from a subject or a light source is incident, the optical filter comprising:
an optical filter body arranged between the subject or the light source and the image sensing device, and having a transmission property for the incident light; and
a light shielding film arranged on at least one surface of the optical filter body, having a predetermined pattern shape, and shielding a part of the incident light,
wherein the optical filter body has a transparent substrate, and a first fine uneven structure suppressing reflection of light is provided on at least one interface between the transparent substrate and the light shielding film.

2. The optical filter according to claim 1,
wherein the first fine uneven structure is provided on a surface of the transparent substrate.

3. The optical filter according to claim 1,
wherein an arithmetic average roughness Ra (JIS B0601 (1994)) of the first fine uneven structure is 0.03 μm or more.

4. The optical filter according to claim 1,
wherein a maximum height Ry (JIS B0601 (1994)) of the first fine uneven structure is 0.1 μm or more.

5. The optical filter according to claim 1,
wherein an average interval S between local peaks (JIS B0601 (1994)) of the first fine uneven structure is 5.5 times or less of a maximum height Ry (JIS B0601 (1994)) of the first fine uneven structure.

6. The optical filter according to claim 1,
wherein the first fine uneven structure has a convex portion whose height exceeds 100 nm, and a rising angle of the convex portion is 20° or more.

7. The optical filter according to claim 1,
wherein a refractive index difference (Δn) of materials forming the interface on which the first fine uneven structure is formed is 0.3 or less.

8. The optical filter according to claim 1,
wherein a second fine uneven structure is formed on a surface of the light shielding film on an opposite side of the transparent substrate.

9. The optical filter according to claim 8,
wherein an arithmetic average roughness Ra (JIS B0601 (1994)) of the second fine uneven structure is 0.1 μm or more.

10. The optical filter according to claim 8,
wherein an average interval S between local peaks (JIS B0601 (1994)) of the second fine uneven structure is 1 μm to 100 μm.

11. The optical filter according to claim 8,
wherein a maximum height Ry (JIS B0601 (1994)) of the second fine uneven structure is 2 μm or more.

12. The optical filter according to claim 1,
wherein the light shielding film is composed of a resin film.

13. The optical filter according to claim 1,
wherein the light shielding film is composed of a multilayered film formed by alternately stacking an oxide dielectric film and a metal film.

14. The optical filter according to claim 1,
wherein the optical filter body has at least one layer of optical functional layer formed on at least one surface of the transparent substrate.

15. The optical filter according to claim 1,
wherein the light shielding film is provided to an outer peripheral portion on the transparent substrate, and at least one layer of optical functional layer is provided to a center portion so that the layer is brought into contact with an end face of the light shielding film on the inside of the outer peripheral portion.

16. The optical filter according to claim 15,
wherein the optical functional layer includes a light absorption film which absorbs light in a specific wavelength region.

17. The optical filter according to claim 15,
wherein the optical functional layer includes an antireflection film.

18. An imaging apparatus, comprising:
an image sensing device receiving light from a subject or a light source;
a lens disposed between the subject or the light source and the image sensing device; and
the optical filter according to claim 1, which is disposed between the subject or the light source and the image sensing device.
